(19) United States
(12) Patent Application Publication
(10) Pub. No.: US 2008/0052975 A1
(43) Pub. Date: Mar. 6, 2008

(54) Memorabilia Storage System

(76) Inventors: Daren Harline, Lone Tree, CO (US); John Romano, Highlands Ranch, CO (US)

Correspondence Address: LATHROP & GAGE LC, 4845 PEARL EAST CIRCLE, SUITE 300, BOULDER, CO, 80301, US

(21) Appl. No.: 11/858,000

(22) Filed: Sep. 19, 2007

Related U.S. Application Data
(62) Division of application No. 10/842,768, filed on May 11, 2004, now abandoned.

(51) Int. Cl. G09F 3/20

(52) U.S. Cl. 40/654.01; 402/4

(57) ABSTRACT

A memorabilia storage system for recording, organizing and preserving mementos is disclosed. The memorabilia storage system provides electronic templates which facilitate recording of event data on an information sheet. A memento may then be associated with an information sheet and numerous information sheets may be stored in an archive journal.

This application is a Divisional of U.S. application Ser. No. 10/842,768, filed May 11, 2004, which is incorporated herein by reference.

### BACKGROUND

1. Field of the Invention

The invention pertains to storage systems for memorabilia. More particularly, the storage system retains and organizes memorabilia from sports, entertainment, and/or political events.

2. Description of Related Art

Many people enjoy sports and entertainment memorabilia. In fact, Americans spend approximately $4 billion per year on sports collectables. They collect, trade, sell, and display their sport and entertainment artifacts so that other memorabilia enthusiasts may enjoy them. Additionally, personal memorabilia, which carries sentimental value, is frequently organized and shared with friends and family. It can, however, be a daunting task to catalogue and inventory large quantities of memorabilia. Therefore, it is not uncommon for newspaper clippings, event programs, ticket stubs, photographs, cards and the like to wind up in unorganized boxes or drawers. Information associated with mementos of such unorganized collections is often forgotten, irretrievably lost, or damaged under bulk storage conditions.

Several sports memorabilia storage systems are known. By way of example, game ball holders are described in the following patents: U.S. Pat. No. 6,655,056; U.S. Pat. No. 6,220,441; and U.S. Pat. No. 6,199,804.

Additionally, several collectable card holders are also known, such as those described in the following patents: U.S. Pat. No. 6,546,651; U.S. Pat. No. 6,295,750; U.S. Pat. No. 6,282,826; and U.S. Pat. No. 5,190,127.

### SUMMARY OF THE INVENTION

The present memorabilia storage system overcomes the problems outlined above and advances the art by providing an organizer that, for example, stores memorabilia for easy retrieval while protecting the memorabilia from damage.

The memorabilia storage system may include one or more components configured for cooperative use, such as an archive journal, one or more event sleeves and/or one or more independent information sheets, a program disk for use on a single personal computer, and a pocket for securing the program disk.

The event sleeves are preferably made from a transparent plastic material, wherein the plastic material may impart ultraviolet protection to the contents of the sleeve. Each event sleeve contains a main opening for receiving an information sheet, and an auxiliary pocket for housing a memento of complementary dimensions. The auxiliary pocket may be substantially vertical or substantially horizontal relative to the information sheet. Preferably, the auxiliary pocket and the contents thereof do not obscure text on the information sheet. Event sleeves may be secured in the archive journal, e.g., via a ring or clip binder system, and may be easily inserted and removed therefrom.

In one embodiment, independent information sheets may be made from substantially thick paper (e.g., cardstock) and mementos may be attached directly to the independent information sheets via corner tabs, corner slits, adhesive material, fasteners or other known means. Independent information sheets may be produced with retainers for securing them in the archive journal or such retainers them may then be applied after printing. The paper for the information sheet may be a standard sized paper, such as 8½″×11″, but alternate sizes of any suitable dimension may also be used.

In a particular embodiment, the archive journal may contain a locking mechanism. The locking mechanism is meant to ensure the privacy of the owner of the archive journal and prevent or deter the theft of valuable memorabilia.

The program disk may be an optical storage medium, such as a CD, or DVD, or a magnetic storage medium. The program disk contains memorabilia software that may be used with a single personal computer. The software provides the user with various templates for producing information sheets, which may be printed by a standard computer printer. The software templates may include drop-down menus used, for example, to select teams, cities and stadiums. The templates may further include orientation features for user-selection of the paper layout of the information sheet, together with placement of the auxiliary pocket and memento relative to the information sheet according to one of a plurality of predetermined formats.

The software may include program instructions for linking digital pictures to an electronic information sheet and/or for connecting the software user to a memorabilia Internet site. Electronic records of the information sheets may be electronically stored, edited and searched, for example, by use of a database and associated user-selectable query instructions. The software may also include program instructions for producing nonexistent ticket stubs or replacing missing ticket stubs based on data entered by user. For example: a ticket stub may be created to indicate teams, scores, date, city, stadiums, etc., according to a downloaded format or a predetermined ticket stub format. These ticket stubs may be used if the ticket memento is missing or stolen, or to provide a memento for a sporting event where tickets may not be provided, such as many high school sporting events.

The memorabilia Internet site may be accessed either through software on the program disk or by use of an Internet browser. The memorabilia Internet site permits a community of users to acquire information pertaining to a past event, such as a sports program, photographs, artist biography, or player statistics. A secondary market may be created for sale and purchase of historical memorabilia merchandise, such as past sporting and event tickets, balls, and any other memorabilia.

The term “memorabilia” as used in the present application may be any substantially flat item of popular appeal or sentimental value. “Mementos” may include, for example, tickets to sporting events, conceit tickets, backstage passes, theater tickets, baseball cards, superhero cards, event programs, newspaper clippings, photographs, stamps, drawings, greeting cards, party invitations, letters, and the like.

The memorabilia storage system may thus provide certain advantages over the prior art. For example, it may provide a user-written account of event information to be stored and displayed along with the memorabilia, e.g., we attended this game with Jim and Sue. Additionally, the information sheets may be electronically stored, edited, displayed, and searched using a personal computer, personal data assistant (PDA), cellular telephone, or other suitable electronic device. Electronic files, such as digital pictures, may be linked to an electronic information sheet. Certain aspects of the event information may be researched and downloaded from an internet website.

### BRIEF DESCRIPTION OF THE DRAWINGS

FIG. 1 shows a front plan view of one embodiment of an exemplary information data sheet.

FIG. 2a shows a front perspective view of one embodiment of an event sleeve, wherein the event sleeve has a vertical auxiliary pocket.

FIG. 2b shows the embodiment of FIG. 2a wherein the event sleeve contains an exemplary information data sheet and the vertical auxiliary pocket contains a ticket stub.

FIG. 3a shows a front perspective view of one embodiment of an event sleeve, wherein the event sleeve has a horizontal auxiliary pocket.

FIG. 3b shows the embodiment of FIG. 3a wherein the event sleeve contains an exemplary information data sheet and the horizontal auxiliary pocket contains a ticket stub.

FIG. 4 shows, for exemplary purposes, an internal perspective view of a memorabilia storage system, containing several event sleeves and an electronic medium in a storage pocket.

FIG. 5a shows an independent information sheet of one embodiment of the present invention comprising adhesive patches for securing a memento to the information sheet.

FIG. 5b shows an independent information sheet of one embodiment of the present invention comprising corner slits for securing a memento to the information sheet.

FIG. 5c shows an independent information sheet of one embodiment of the present invention comprising corner tabs for securing a memento to the information sheet.

FIG. 5d shows an independent information sheet of one embodiment of the present invention comprising a fastener for securing a memento to the information sheet.

FIG. 6 schematically illustrates program code or programmable instructions that may be provided on a program instruction disk that accompanies the system.

FIG. 7 demonstrates a community of users connected to a website server that permits the users to share information and trade memorabilia.

FIG. 8 illustrates program instructions for use on the website server.

FIG. 9 shows a screen layout for a program initialization page.

FIG. 10 shows screen layout for creating an event record.

FIG. 11 shows a screen layout for maintaining team information.

FIG. 12 shows a search/sort screen for existing event records.

### DETAILED DESCRIPTION OF THE INVENTION

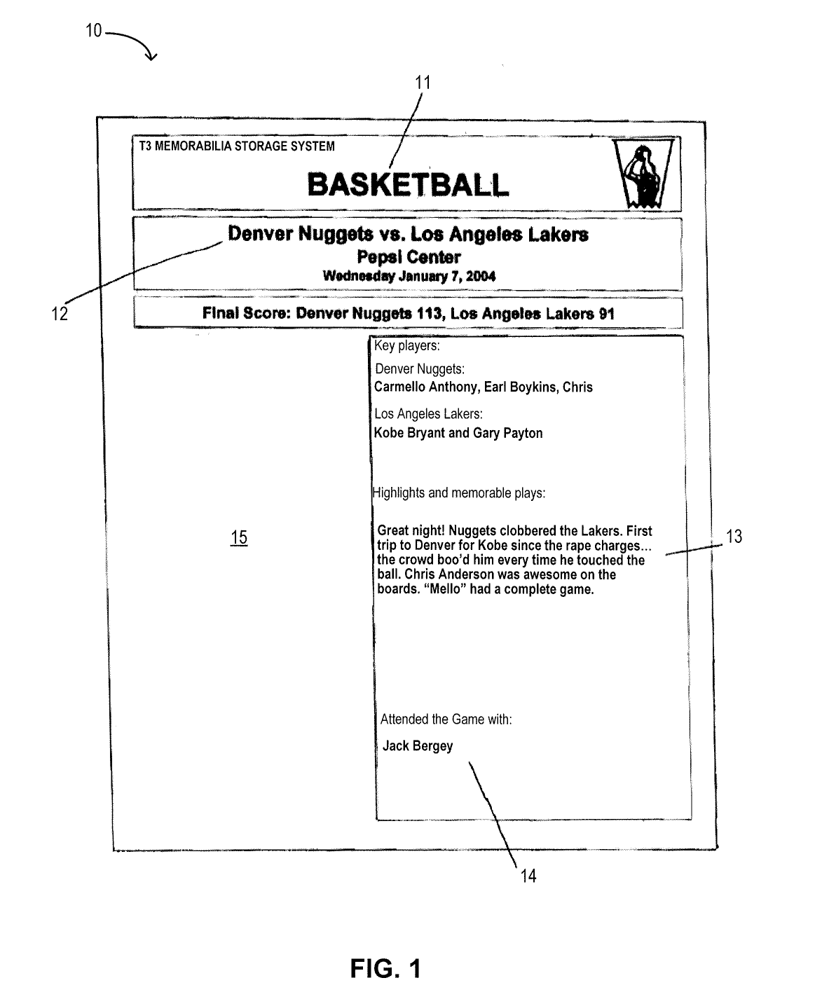

FIG. 1 shows a front plan view of one embodiment of an exemplary information data sheet 10 that is printed in a predetermined format as shown. Typical information data sheets contain a title 11, an event description, date and location 12, highlight information 13, names of attendees 14 and a place for a memento 15.

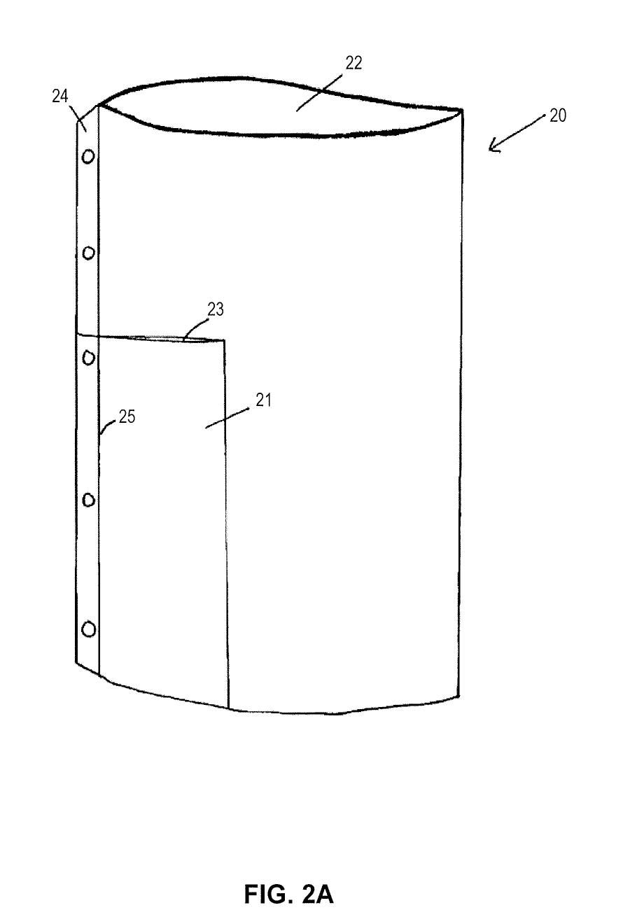

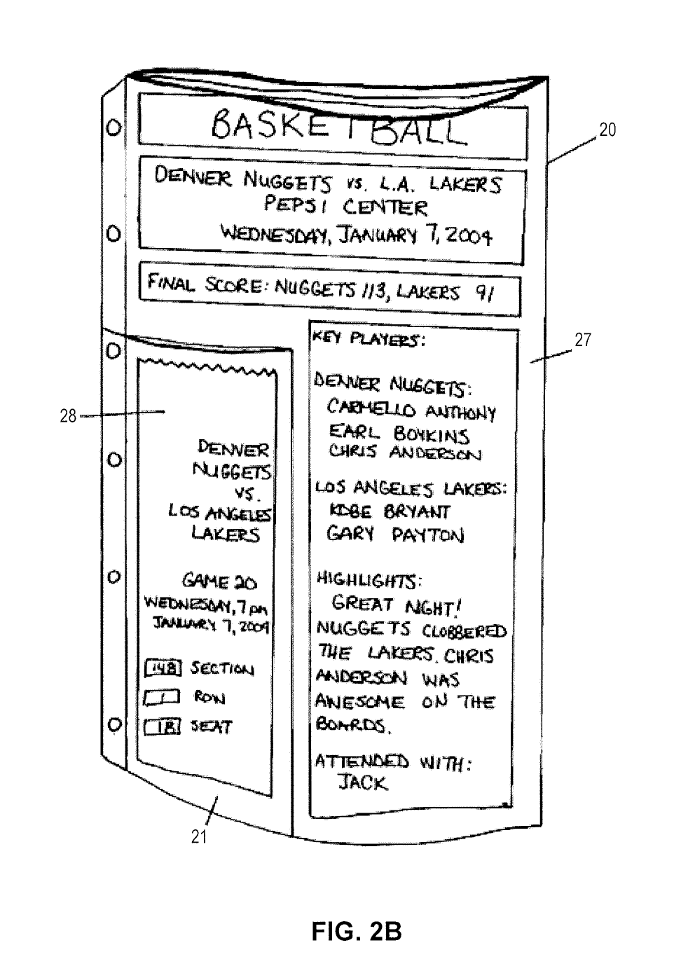

FIG. 2a is a front perspective view of one embodiment of an event sleeve 20, wherein the event sleeve has a vertically elongate auxiliary pocket 21. Event sleeve 20 has a main pocket 22 for receiving an information data sheet (not shown). Likewise, a vertically elongate auxiliary pocket 21 has an upper opening 23 for receiving a memento (not shown). Illustratively, event sleeve 20 contains a vertically elongate perforated strip 24 for securing the event sleeve 20 in an archive journal (not shown). The upper opening 23 is substantially parallel with that for main pocket 22. A common edge 25 is shared by auxiliary pocket 21, main pocket 22, and perforated strip 24. This construction advantageously provides economy of manufacture, since fewer operations and less materials are required to make an event sheet of this structure than would be required if there were different edges. FIG. 2b shows the event sleeve 20 containing an exemplary information data sheet 27 in main pocket 22. The auxiliary pocket 21 contains a ticket stub or memento 28 that is printed to a suitable vertical standard that is easily legible from the vertically elongate format of auxiliary pocket 21. It has been determined that ideal dimensions for the auxiliary pocket include dimensions of seven inches by three and one half inches and of sufficient depth to be capable of holding a paper or cardboard ticket memento.

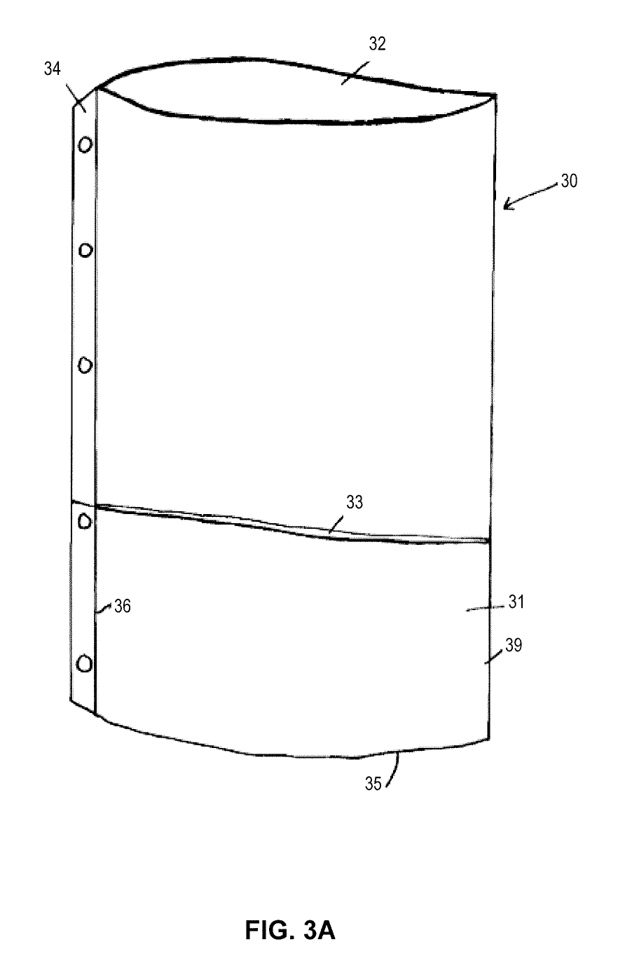

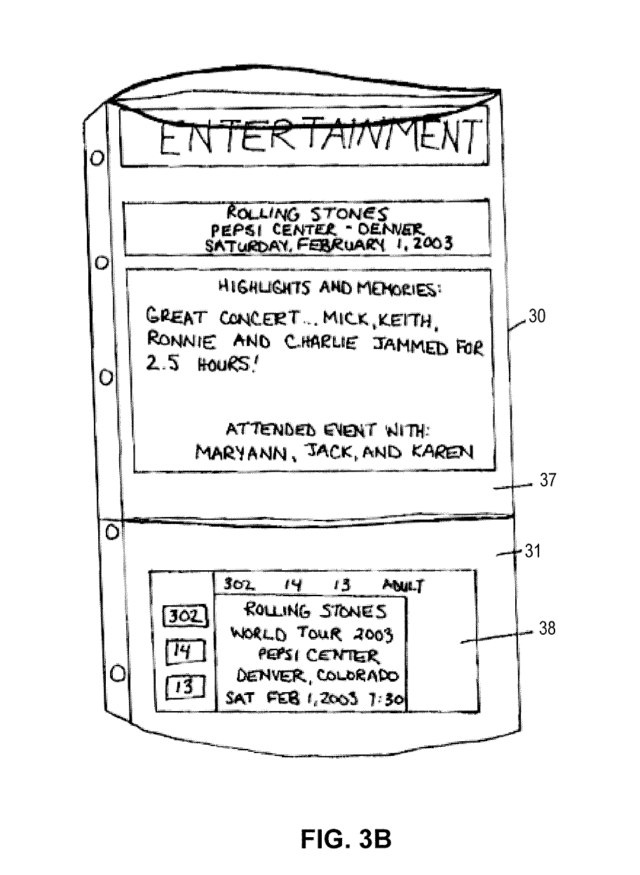

FIG. 3a is a front perspective view of one embodiment of an event sleeve 30, wherein the event sleeve has a horizontally elongate auxiliary pocket 31. Event sleeve 30 has a main pocket 32 for receiving an information data sheet (not shown). Likewise, auxiliary pocket 31 has an upper opening 33 for receiving a memento (not shown). Illustratively, event sleeve 30 contains a perforated strip 34 for securing the event sleeve 30 in an archive journal (not shown). FIG. 3b shows the embodiment of FIG. 3a wherein the event sleeve 30 contains an exemplary information data sheet 37 and the auxiliary pocket 31 contains a ticket stub or memento 38 that is printed to a suitable horizontal standard that is easily legible from the horizontally elongate format of auxiliary pocket 31. Auxiliary pocket 31 shares a bottom edge 35 with main pocket 32, as well as side edge 36 with main pocket 32 and perforated strip 34. Edge 39 is commonly shared between auxiliary pocket 31 and main pocket 32. Upper opening 33 is coextensive with and substantially parallel to that of main pocket 32.

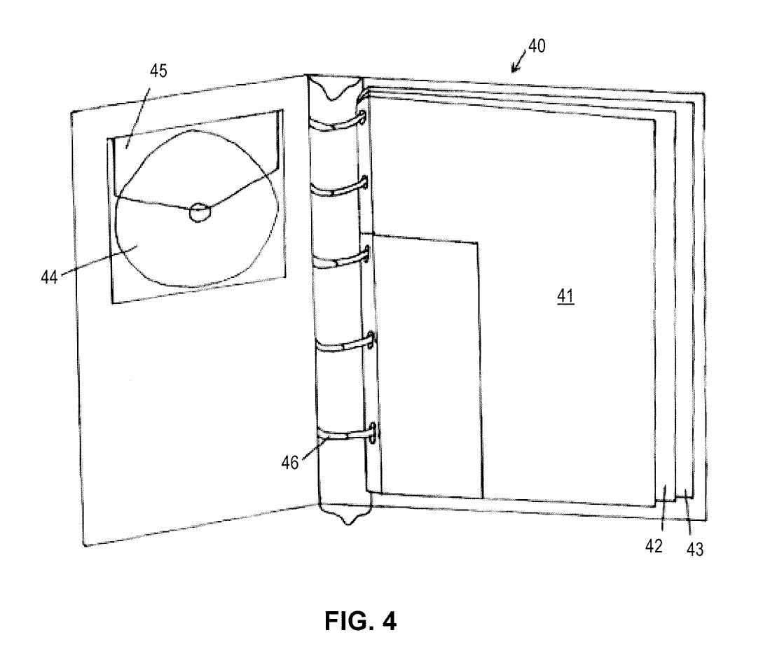

FIG. 4 shows, for exemplary purposes, an internal perspective view of a memorabilia storage system 40 (not to scale), containing several event sleeves 41, 42, 43 and a program disk 44 in a storage pocket 45. The memorabilia storage system 40 may contain a clip assembly (not shown) or ring binder 46 for securing the event sleeves 41,42,43 in the memorabilia storage system 40.

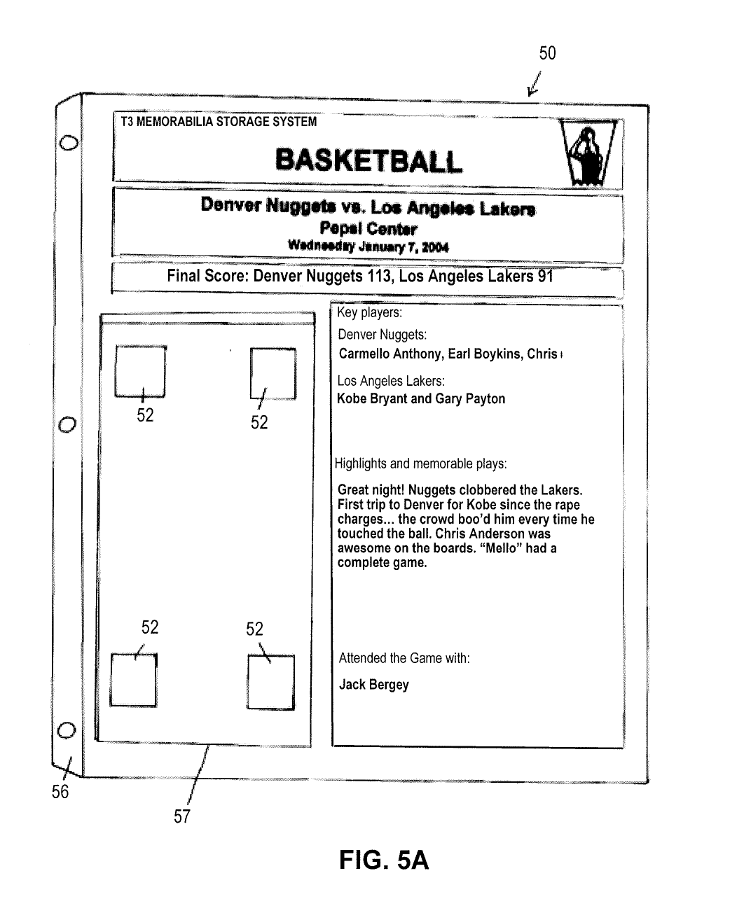

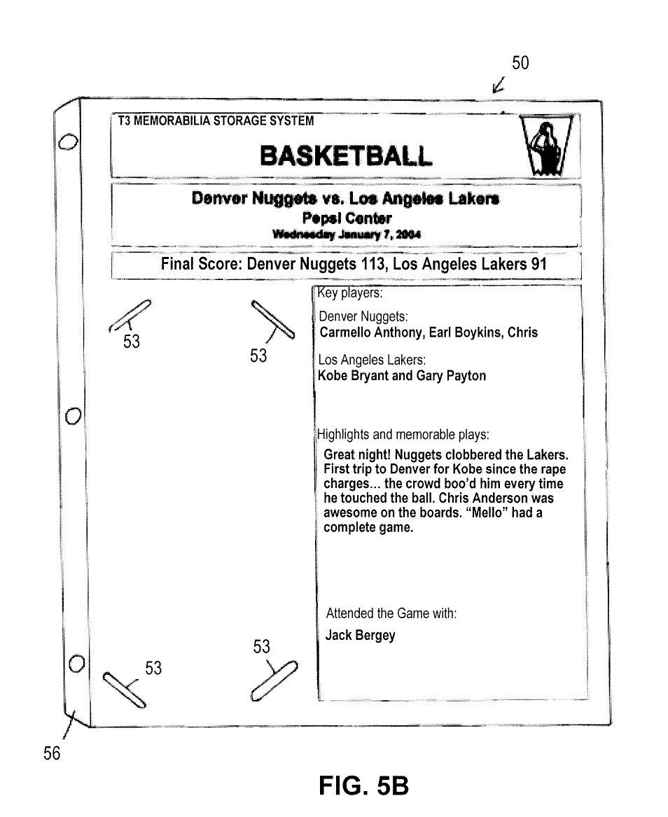

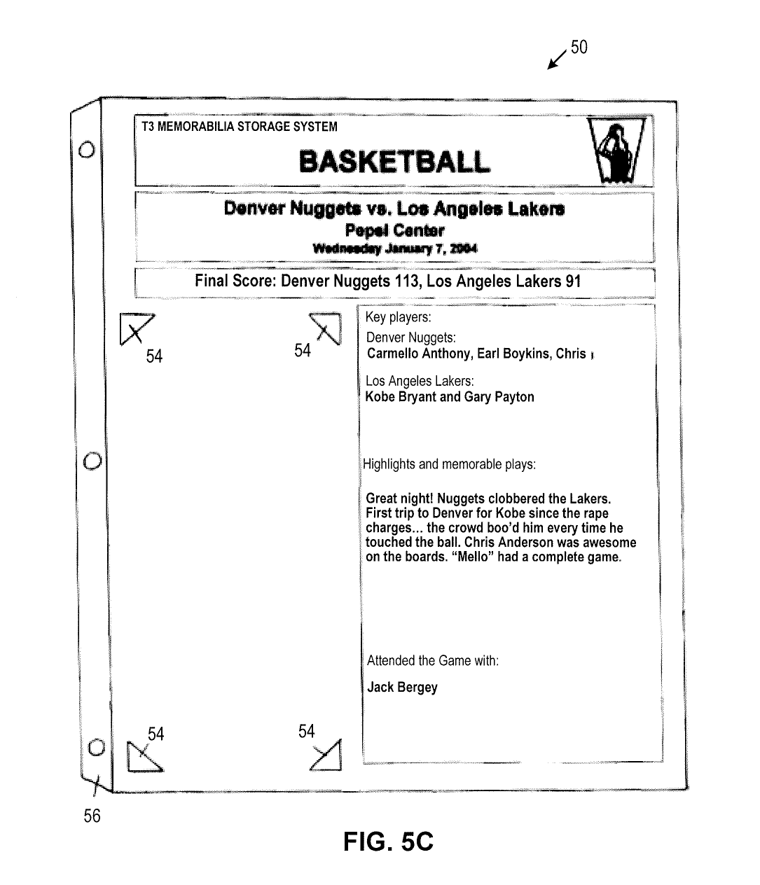

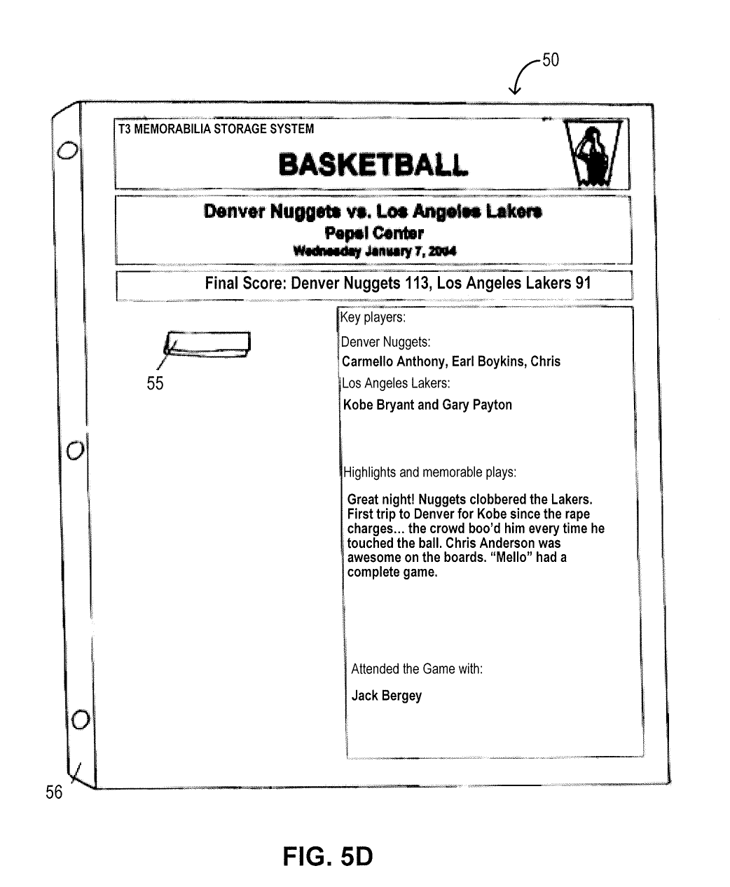

FIGS. 5a-d show various embodiments of an independent information sheet 50 of the present invention comprising various structures for securing a memento (not shown) to the information sheet 50. The illustrated structures for securing a memento to the information sheet 50 include, but are not limited to, adhesive strips 52, corner slits 53, corner tabs 54 and fasteners 55. It will be appreciated that one or more adhesive patches or strips may be used to secure the memento to the information sheet and that the adhesive strip(s) 52 may be of any shape. Likewise, either two or four corner slits 53 or corner tabs 54 will be sufficient to secure a memento. The means for securing the information sheet 56 in the archive journal (not shown) may be formed as part of the information sheet 50 or may be applied after the printing of the information sheet. A protective cover 57, such as that shown in FIG. 5a, may be used with any of the aforementioned embodiments.

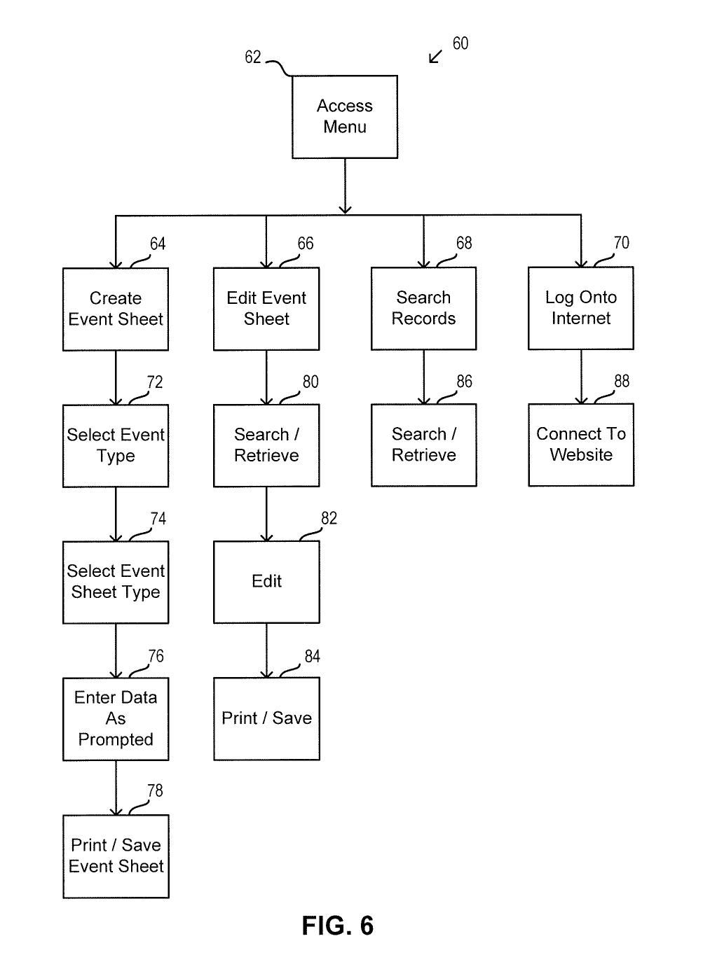

FIG. 6 illustrates program process 60, which may be provided by program code or instructions on a computer readable form, such as program disk 44, when the instructions are installed and operable on a personal computer or server. An access menu 62 provides a plurality of menu option fields that may be click-selected for access to Create Event Sheet functions 64, Edit Event Sheet functions 66, Search records functions 68, and Log onto Internet functions 70. The create event sheet functions 64 are used to create event sheets, for example, as shown in FIGS. 1, 2b, 3b, 5a, 5b, 5c, and 5d. A select Event Type agent 72 permits the user to select from among a plurality of event types, such as concerts, football games, baseball games, hockey games, soccer games, speeches, gymnastic competitions, tennis tournaments or matches, lacrosse games, political rallies, protests, educational seminars, auto races, special events, academic competitions, debates, and any other event type including an option to for the user to define his or her own event type. Sporting event types may be further categorized as school sports, such as elementary, high school and college. Depending upon the type of event selected, the user is prompted to select event type 74 from among a plurality of event sheets having different formats. A drag and drop feature including predetermined shapes may here permit the user to define his or her own event sheet type.

Depending upon the selected event type and event sheet type, the user may Enter Data as Prompted 76 according to predetermined data fields that are relevant to the event type. The data fields may, for example, permit the user to enter personal data about attendance or observations at the event, and may require entry of standard fields, such as date and name of event. Print/Save Event Sheet 78 permits the user to create an event sheet in paper or electronic form. The printed event sheet places information in a predetermined format that is preferably not obscured by the memorabilia where the print locations are complementary to the event sleeve in the sense that the memorabilia may be retained in structure, such as auxiliary pockets 28, 31, adhesive strips 52, corner slits 53, corner tabs 54 or fasteners 55, without obscuring information printed on the corresponding event sheet within the main pocket of the event sleeve. Print/Save Event Sheet 78 also causes the electronic record to be saved in a database for future retrieval and access.

It may be desirable for the user to edit electronic information that is saved, and this is facilitated by Edit Event Sheet functionality 66. The user may enter a Search/Retrieve query 80 to retrieve an event sheet record, and then interactively edit the same using the Edit function 82. The edited record may be printed and saved using the Print/Save function 84. In like manner, the saved event sheet records may be searched and retrieved for review purposes only using a Search Records function 68 to perform a Search/Retrieve query 86.

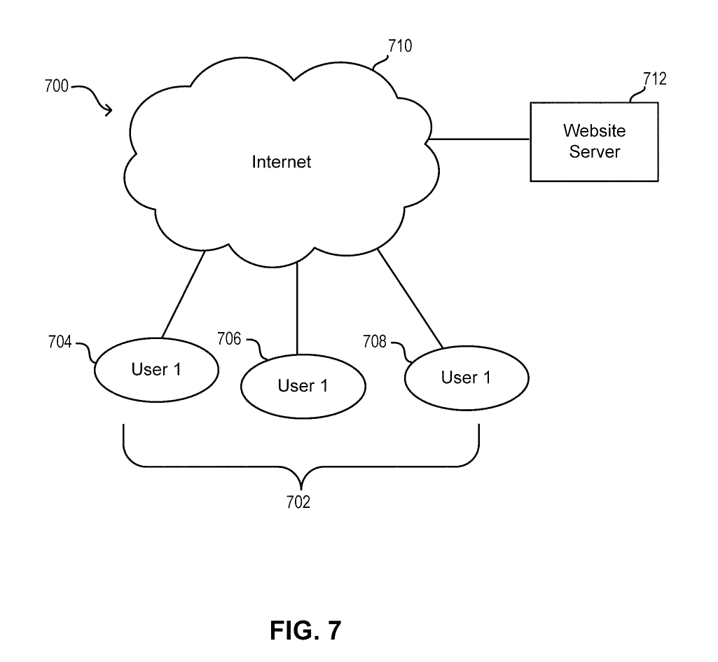

Internet access is provided using a Log onto Internet function 70, which connects to a website using Connect to Website agent 88. FIG. 7 illustrates one schematic structure 700 for connecting to the Internet. A user community 702 includes a plurality of users 704, 706, 708 . . . who use the Internet 710 to connect to a Website Server 712.

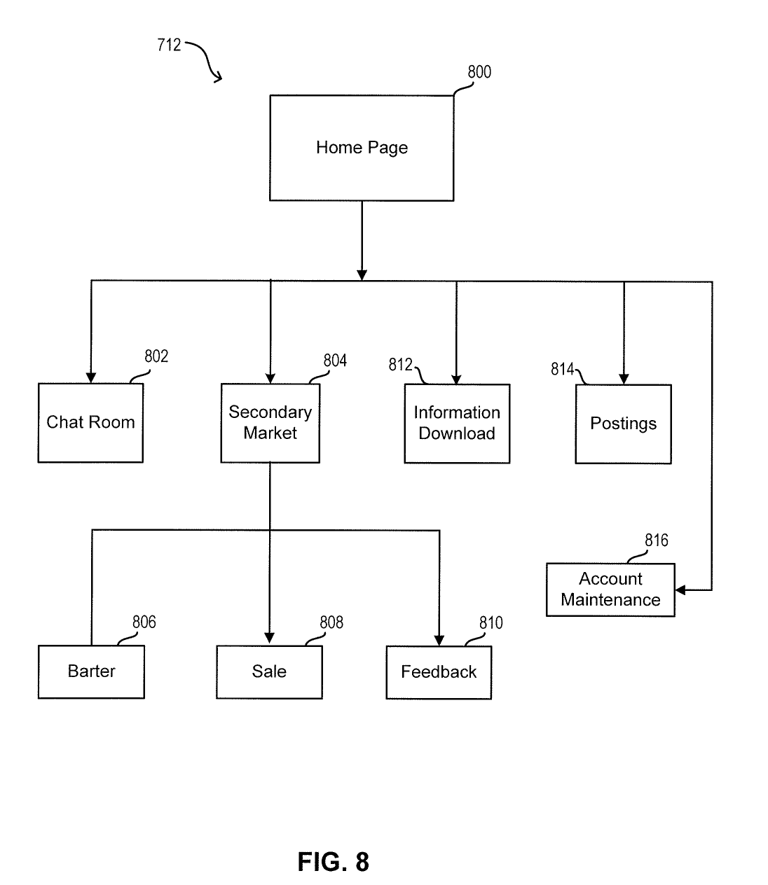

FIG. 8 schematically illustrates functionality that may be provided by program instructions to Website Server 712. Access to Website Server 712 is provided through a Home Page 800, which may perform password authorization of individual or group accounts that are established for the user community 702, either manually or automatically from the program instructions. Home Page 800 provides click access to a chat room 802 where the user community may have ongoing dialog as to any topic of interest. It is possible, for example, to print recollections of individual users who participated in or attended a particular event and to include these recollections as information that is printed on an event sheet.

Home Page 800 also provides click access to a secondary market functionality, which establishes a forum for exchange of memorabilia. The exchange format may include Barter forum 806, where memorabilia is traded for other memorabilia, Sale forum 808 where memorabilia is traded for money at auction or posted sale, and a Feedback function 810 where users express their relative satisfaction with other users in a transaction.

An Information Download service 812 may provide access to historical event information. This information may be accessed from fixed storage associated with Website Server 712, or hyperlinks to other websites that post information for download. The information may be provided for a fee, and can be printed for use on an event sheet. The user community 702 may provide additional information by use of a Postings function 814. Access to this additional information may be secured to limit access to user groups, e.g., by password access or by prior identification of a particular user to a corresponding group.

An Account Maintenance agent 816 permits users to maintain accounts, which may be charged a fee, and to associate individual users with groups of users.

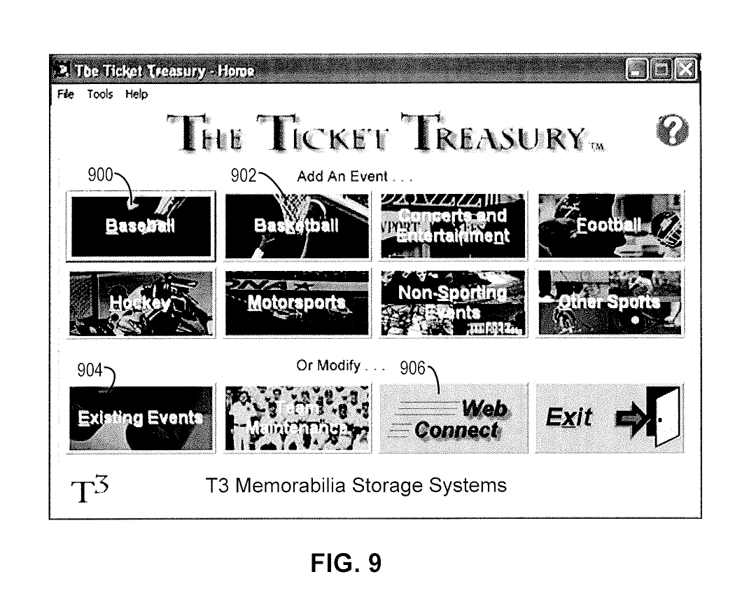

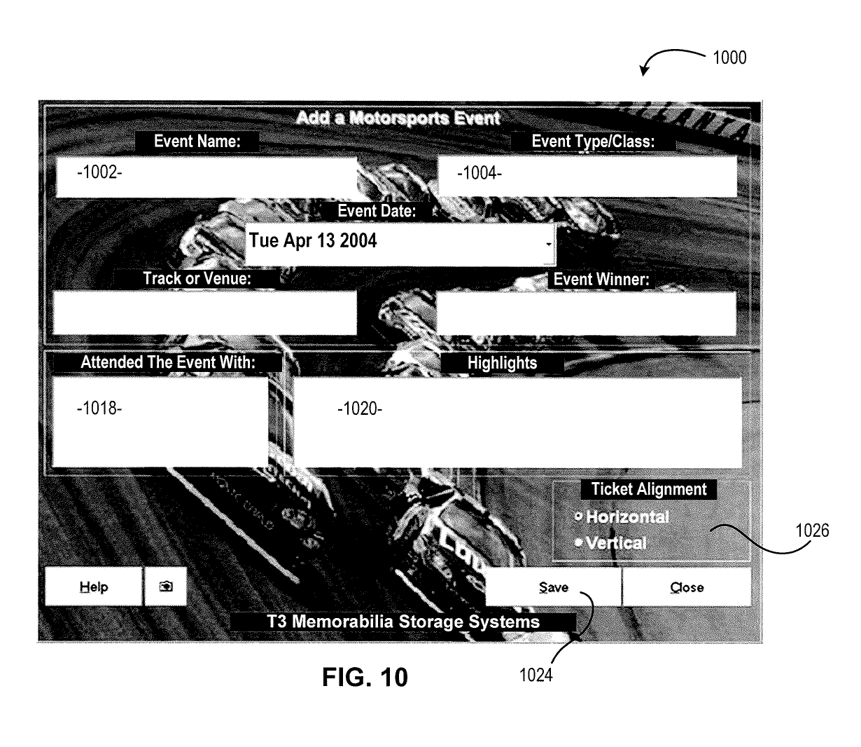

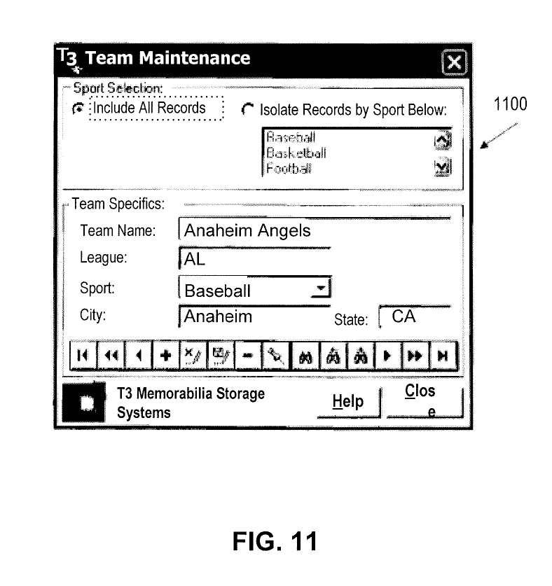

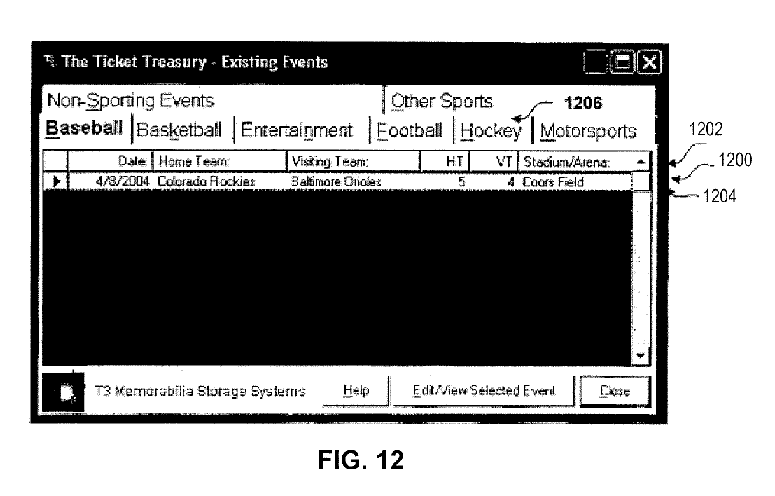

FIGS. 9-12 show various screen layouts that may be used in a graphical user interface that facilitates program processing 60. FIG. 9 shows a program initialization page permitting a user to click-select from among a plurality of predetermined event-type fields, e.g., baseball field 900 or basketball field 902. By way of example, selecting of the baseball field 900 launches a basketball event screen 1000, as shown in FIG. 10., which prompts the user to enter data for a particular baseball game. Data entry is in a predetermined format prompting the user to enter text or numeric data that is germane to a baseball game, for example: Teams 1002, 1002; location 1006; date of game 1008; scores 1010, 1012; key players 1014, 1016; persons in attendance 1018; and game highlight comments 1020. Selection of team maintenance field 1022 launches team maintenance screen 100, which permits entry of team data that may be used to populate or verify team fields 1002, 1004 and location field 1006. Selection of the save field 1024 causes the data to be saved, e.g., in a database, to create an event record, which also results in the printing of an event sheet, for example, event sheet 10 as shown in FIG. 1. For this purpose, text alignment fields 1026 permit a user to select from among a plurality of predetermined formats, such as the format shown generally in FIG. 2b or that of FIG. 3b.

Returning to FIG. 9, selection of the existing events field 904 launches an existing events screen 1200. As shown, a search/report bar 1202 contains a plurality of sort fields, e.g., “Date” and “Home Team,” that may be click-selected to sort a plurality of event records, such as event record 1204. An event type bar contains a plurality of fields, such as: baseball” or “basketball,” that are selectable to retrieve only data for event records for events of the field type. As shown, the “basketball” event type has been selected. Clicking on a field in the event record 1204 launches screen 1000 populated with data for that record for editing and maintenance.

In FIG. 9, selection of field 906 connects the user to a website where, for example, the software may be updated and the functions described above may also occur.

The foregoing instrumentalities thus attain the objects set forth above, among those other objects that are apparent from the preceding description. Since certain changes may be made in the above methods and systems without departing from the scope of the invention, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

Having described the invention, what is claimed is:

1. A system for storing memorabilia, comprising:
a binder that is constructed and arranged to contain at least one event presentation sleeve including a main pocket and an auxiliary pocket each of dimensions that complement one or more event sheets that may be stored therein, where the location of the auxiliary pocket on the event presentation sleeve does not substantially overlie the main pocket on the event presentation sleeve when events sheets are stored;
a computer program and event storage medium on which resides a graphical user interface (GUI) based computer program with program instructions for cataloging, storing, printing and tracking data in association with a template format that pertains to a type of event sheet which may reside in one of the main pocket and the auxiliary pocket on the presentation sleeve; and
a pocket for stowing the GUI-based computer program and storage medium, the storage medium being provided with additional program instructions for generating electronic records associated with the printable event sheet, and searching the generated records for retrieval of the electronic records.

2. The system of claim 2, wherein the additional program instructions are operable to search using network connectivity to complete the search.

3. The system of claim 2, further comprising a location on the Internet storing a plurality of searchable records generated form among a community of users, the system being configured to create a market for the exchange of records among the community of users.
